(19) United States
(12) Patent Application Publication
(10) Pub. No.: US 2014/0180765 A1
(43) Pub. Date: Jun. 26, 2014

(54) WEB-BASED SURVEY VERIFICATION

(71) Applicant: INTELLISURVEY, INCORPORATED, Ladera Ranch, CA (US)

(72) Inventors: ROBERT REGINALD MESSER, LADERA RANCH, CA (US); JONATHAN EPHRAIM, PACIFIC PALISADES, CA (US)

(73) Assignee: INTELLISURVEY, INCORPORATED, LADERA RANCH, CA (US)

(21) Appl. No.: 13/722,836

(22) Filed: Dec. 20, 2012

(51) Int. Cl. G06Q 30/02

(52) U.S. Cl. CPC G06Q 30/0203
USPC 705/7.32

(57) ABSTRACT

Provided is a method for verifying the accuracy of a response to a web-based survey. The method includes providing a survey on a website and receiving a survey response from an electronic device associated with a respondent, as well as receiving verification data from the electronic device. The verification data is analyzed to determine a likelihood of cheating. The survey response is saved in an authentic database when the likelihood of cheating is below a threshold.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to online, web-based survey authentication, and more specifically to a system and method of determining a likelihood of cheating associated with a survey response.

2. Related Art

Statistical surveys are utilized in a wide variety of settings to collect quantitative data of a population for further analysis and assessment. These include political polling, marketing research, social science research, and dispute resolution, among many others. The standardized inquiries made in the surveys may range from the purely factual, such as demographics, to opinions, such as how a person feels about an issue or a potential new product, or a combination of both. Surveys are understood to be an efficient method of collecting information from a large number of people.

In general, marketing research collected in surveys is useful in understanding the wants, needs, and behaviors in the marketplace, both in the present as well as in the future. The research is applied to business-to-business and business-to-consumer applications to better focus product development, marketing, and sales efforts.

One of the most effective ways of reaching a large group of people when conducting a survey is to host the survey online. In this regard, anyone with Internet access may be a potential respondent and can participate in the survey. With the development of several web-based products, such as smart phones, tablet computers, and laptop computers, it has become easier to access the Internet for a large group of people. Thus, conducting a web-based online survey may allow the operator of the survey to receive quick results from a large respondent pool.

Typically, a web-based online survey is operated by posting the survey at a specific web address and inviting respondents to complete the survey by sending them an email messages, posting advertisements, or other methods. In many cases, particularly for longer surveys, respondents may be paid for completing the survey.

When the survey responses are submitted, the results are tabulated and the results of the survey are determined. In order to obtain the most accurate survey results, it is important to obtain survey responses from respondents within a desired survey pool. It is also critical that the responses are genuine, i.e., truly representative of the respondents. In this regard, genuine responses originate from respondents who pay attention, read the questions, and respond honestly, rather than submitting random responses. In more traditional research methodologies, such as live in person surveys and phone interviews, it is relatively straightforward to reliably determine if the respondent is answering truthfully and thoughtfully.

One concern commonly associated with online surveys is detecting and mitigating cheating by online survey respondents. There may be large groups of people across the globe that are outside of the intended survey pool randomly clicking or submitting answers to the online survey. Furthermore, there may be several motivating factors which may cause an individual or group to cheat on an online survey. An exemplary motivating factor may include intentional sabotage from a group or individual wanting to distort the results of the survey. Due to the anonymity associated with the respondents, it may be hard to gauge the authenticity and accuracy of a respondent's answer. If cheating occurs, the survey results may be inaccurate or skewed.

Accordingly, there is a need in the art for detecting cheating in web-based online surveys.

### BRIEF SUMMARY

In accordance with one embodiment of the present disclosure, there is contemplated a method for verifying the accuracy of a response to a web-based survey. The method includes providing a survey on a website and receiving a survey response from an electronic device associated with a respondent, as well as receiving verification data from the electronic device. The verification data is analyzed to determine a likelihood of cheating. The survey response is saved in an authentic database when the likelihood of cheating is below a threshold. The data in the authentic database may then be compiled to generate a survey summary.

The above-described method is directed toward mitigating the problem of cheating on web-based surveys. The method compiles various bits of data about each respondent completing the online survey and uses that information to determine whether cheating has occurred. In this regard, the data is gathered in an attempt to remove some of the anonymity associated with online surveys. If after analyzing the data, it is determined that cheating has occurred, or there is a high likelihood that cheating has occurred, then the response is disregarded.

The method may further include the step of saving the survey response in a cheating database when the likelihood of cheating meets or exceeds the threshold.

The step of receiving verification data may include receiving electronic identification data associated with the electronic device. Furthermore, the step of analyzing the verification data to determine a likelihood of cheating may include comparing the electronic identification data with a historical electronic identification database to identify duplicative responses, and designating a likelihood of cheating above the threshold when at least one duplicative response are identified. The electronic identification data may include at least one in the group comprised of: an IP address, cookie data, web browser data, and plug-ins installed on a web browser.

The step of receiving verification data may also include receiving respondent input data associated with the input of the survey response by the respondent. Moreover, the step of analyzing the verification data to determine a likelihood of cheating may include comparing the respondent input data with a low probability respondent input database and designating a likelihood of cheating above the threshold when no match is found between the respondent input data and the low probability respondent input database.

The respondent input data may include at least one in the group comprised of: time zone data associated with the respondent's input, the time spent by the respondent for completing a portion of the survey, the number of mouse clicks on a webpage, and the number of times a key was pressed on a webpage.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating one environment in which various respondent computers communicate with a central server for completing a survey;

FIG. 2. is a block diagram of an exemplary web server;

FIG. 3 is a block depicting a method of verifying the accuracy of a web-based survey according to one embodiment of the present disclosure; and

FIG. 4 is a block diagram illustrating one embodiment of an authentication system.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first, second, and the like are used solely to distinguish one entity from another without necessarily requiring or implying any actual such relationship or order between such entities.

Various aspects of the present invention are directed toward implementing a system and method to verify the accuracy of an online survey response so as to reduce the frequency of online cheating. Those skilled in the art will readily appreciate that authentic answers from intended survey respondents provide the most accurate survey results. Thus, the systems and methods described herein are aimed at identifying survey responses which have a high likelihood of being unauthentic or unauthorized and disregarding those responses when compiling the survey results. As described in more detail below, the verification process entails analyzing various bits of data associated with the survey response to determine a probability of respondent cheating. If the probability of cheating is high, the survey response may be disregarded (i.e., not used in compiling the survey results). Conversely, if the probability of cheating is low, the survey response may be included in the survey tabulation.

As used herein, the term “cheating” may refer to submitting a survey response that is from a respondent who is not part of the intended survey pool. Furthermore, cheating may also refer to a duplicative response when conducting a survey where only one response is allowed for each respondent. Cheating may also refer to other responses that do not meet certain response parameters as set by the survey operator. In this regard, the term cheating does not necessarily refer to the intent of the respondent, i.e., the intent to cheat or submit a fraudulent survey response. In this regard, the respondent may be responding with a genuine, authentic answer, although the respondent may not be part of the intended survey pool, and therefore, the response may be referred to as cheating.

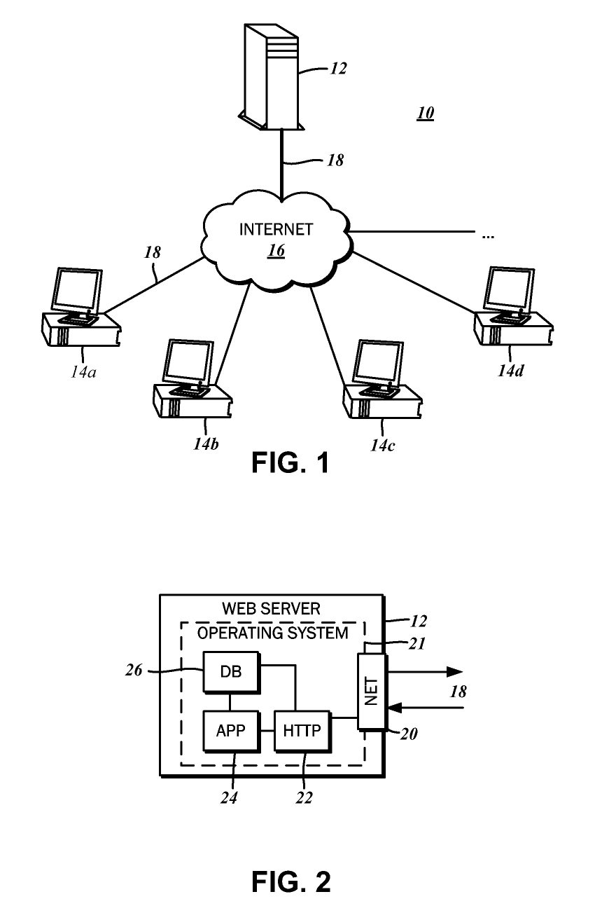

According to one embodiment of the present invention, the method includes providing an online survey. Referring now specifically to FIG. 1, there is shown a schematic diagram of a system 10 configured to conduct an online, web-based survey. The system 10 includes a central server 12 and several respondent computers 14a-14d which communicate with the central server 12 via the Internet 16. Each respondent computer 14a-d includes a respective Internet connection 18 linking the computer to the Internet 16. Furthermore, the central server 12 also includes an Internet connection 18 linking it to the Internet 16. It is understood that in one embodiment, the central server 12 is a conventional computer system having a processor capable of executing the noted instructions of the method described herein, as well as a memory for storing the instructions and other related data.

FIG. 2 shows an embodiment of the central server 12 including a network interface 20 representative of the physical device connecting the central server 12 to the Internet 16, such as an Ethernet network interface card, as well as the logical module or protocol stack providing the various higher level communication functions for Internet Protocol (IP) networking.

The central server 12 may include a base operating system running thereon, which may be similar to most computer systems configured to serve web pages. The operating system may manage one or more server applications including a HyperText Transfer Protocol (HTTP) server 22 that receives requests (in the form of Uniform Resource Identifiers, or URIs) for a specific HyperTest Markup Language (HTML) document, and transmits that document back to the requestor. Additional data outside the scope of the document may be retrieved from a separate database 26. Survey data received from the respondent, the details of which will be described in more detail below, may also be stored on the database 26. The central server 12 includes an application module 24 that further extends interactivity and web-accessible data processing capabilities.

In the exemplary web-based survey system 10, data for the various questions may be stored in the database 26. Although it is possible to provide static web pages, the application module 24 may handle the dynamic generation of each page of the survey by populating the same with the questions from the database 26 and incorporating standard content. In this regard, the sequence of questions may be altered depending on the answer given by the respondent. The HTTP server 22 may then transmit the generated pages to the requestor, i.e., the respondent computers 14a-14d, to be rendered thereon by a conventional web browser application well known in the art.

Sending web pages to the requestor is one function performed by the HTTP server 22, and for purposes of conducting the survey, responses to those inquires are also received thereby. As will be recognized, conventional HTML documents have several user input controls such as radio buttons, selection/check boxes, text input boxes, and so forth, that may be utilized to provide responses. The state of the various input controls are submitted to the HTTP server 22, where they are parsed and stored on to the database 26. In accordance with various embodiments, the selection of the HTML forms-based input controls in the survey and providing data to the same is referred to as the submission of a response. The use of alternative input methods is not foreclosed, however, and any other way of submitting information to the central server may be substituted. It is also possible for these submitted responses to alter the execution sequence of the survey or any other set of instructions being performed by the application module.

Management of the survey may be implemented on the central server 12 in connection with its constituent components including the network interface 20, the HTTP server 22, the database 26, the application module 24, and others as necessary.

Respondents answer the survey through the respondent computers 14a-14d, which are understood to be general-purpose personal computer systems capable of running various applications including the aforementioned web browser application, and is capable of being connected to the Internet 16 via individual Internet connections. A variety of modalities with respect to the Internet connections 18 are known, and any one may be utilized in order to communicate with the central server 12. In general, the respondent computers 14a-14d are understood to have input and output devices, data storage, and one or more microprocessors. As will be appreciated by those having ordinary skill in the art, the respondent computers may be of any suitable variation, and any number of different respondent computers besides those specifically shown in FIG. 2 may concurrently communicate with the central server. Exemplary respondent computers 14a-14d include, but are not limited to, personal computers, tablet computers, smart phones, or any other computing device known in the art that is capable of communicating via the Internet 16.

The foregoing description of the various hardware components have been presented by way of example only and not of limitation, and any other suitable component may be readily substituted without departing from the scope of the disclosure. Furthermore, the specific functionalities associated with such components are also exemplary; several different functions may be integrated into a single component, or various subparts of a single function may be performed by several different components.

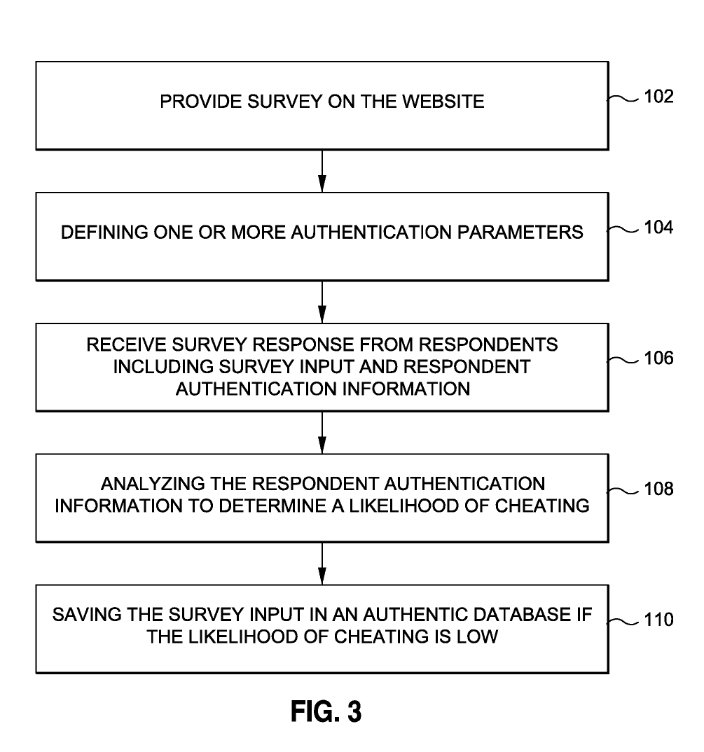

Referring now specifically to FIG. 3, there is shown a flowchart outlining the steps associated with one embodiment of the survey verification method. The previous discussion pertains to step 102 of the flowchart, which relates to providing the survey on the website. The address for the website may be communicated to a pool of potential respondents by one or more means of communication, including but not limited to, email, text message, social media (i.e., Facebook™, Twitter™), an advertising campaign, telephone call, etc. Once respondents visit the website, they may access the survey and submit a survey response.

Those skilled in the art will recognize that although the present discussion describes the online survey as being hosted on a website visited by respondents, other surveys may be conducted online, i.e., via the Internet or other networking means, such as a survey conducted through email, text message and the like, wherein the respondent is not required to visit a website, but instead, fills out a survey and then sends the survey back to the survey operator via the Internet, cellular communication, or other communication means.

The survey response typically includes survey input data and respondent authentication information, i.e., verification data. The survey input data is the respondent's answer or input to the survey. The respondent authentication information is data or information associated with the survey input data that is analyzed/processed to determine whether or not the survey input data is authentic. The respondent authentication information is used to remove some of the anonymity associated with online surveys. In this regard, the respondent authentication information provides certain details about the respondent which may be used to determine a likelihood of cheating in relation to the respondent's answer.

The respondent authentication information may include, electronic identification data associated with the electronic device, such as the respondent's IP address, a cookie set by the survey server, various data sent by the web browser including the user agent, or the plug-ins installed in the browser. In this regard, the electronic identification information characterizes the electronic device used by the respondent.

It is also contemplated that the respondent authentication information may include respondent input data, which more specifically characterizes the respondent or the respondent's survey response. Exemplary respondent input data may include, but is not limited to the respondent's timezone, the amount of time the respondent spent on a portion (i.e., page) of the survey, the number of mouse clicks on the page, the number of times a key was pressed on the page, whether or not the respondent failed any validation checks.

The method continues to step 104, which includes defining one or more authentication parameters which are used to analyze the respondent's answer to determine a likelihood of cheating. The authentication parameters may be selectively set by the operator/controller of the survey. In this regard, one or more authentication parameters are effectively used as a filter to determine which survey responses are likely to be the result of cheating and which responses are likely to be authentic and should be used in the final survey results.

The authentication parameters may relate to various qualities or characteristics associated with the respondent's answer. In most cases, the authentication parameters correspond to at least one aspect of the respondent authentication information. For instance, the authentication parameters may define the intended survey pool (i.e., respondent location) or may relate to the survey response (i.e., duplicative). In this regard, the authentication parameters relate to at least one aspect of the respondent's answer for purposes of determining a likelihood of cheating.

The following is an example of how the authentication parameters may be used to determine a likelihood of cheating. It is contemplated that some surveys are intended for respondents living within a certain geographic area, i.e., within the United States. Therefore, responses from individuals living outside of the United States are not desired. When a respondent submits an answer, the signal containing the answer may also include other bits of information, including the IP address of the respondent's computer. The IP address may be used to determine where the respondent was located when the answer was submitted. Therefore, the authentication parameters may relate to the IP address of the respondent. If the IP address corresponds to a location with in the United States, the likelihood of cheating is low (or zero). Alternatively, if the IP address corresponds with a location within the United States, the likelihood of cheating is high (or certain).

Depending on the nature of the information being received and analyzed during the verification process, the authentication parameters may be set to define an authentication range. For instance, the authentication range may relate to the amount of time spent on a page of the survey, or the number of clicks made by the respondent when completing the survey. If it is determine that the user's answer includes information which falls outside of the preset range, the likelihood of cheating increases, and conversely, if the answer includes information that falls within the preset range, the likelihood of cheating decreases.

The authentication parameters may be set by operators of the survey who have conducted research to determine data used to identify answers that are likely the result of cheating and answers that is not likely the result of cheating. For example, it may be determined that for a given survey, it may take an average respondent 2-4 minutes to answer the questions on one page of the survey. Thus, the authentication parameters may relate to the time spent on that page of the survey. In that case, when the survey response is submitted, the verification information may include the time spent on that page of the survey. If the respondent's time spent on that page falls outside of the preset range, i.e., outside of 2-4 minutes, then the likelihood of cheating is high, and if the respondent's time spent on that page is within the range, i.e, within 2-4 minutes, then the likelihood of cheating is low.

Referring again back to FIG. 3, the method continues with step 106, which includes receiving a survey response from a respondent. It is contemplated that the central server 12 may receive the survey response in real time or after the completion of the survey by the respondent. Along these lines, the survey response may be communicated from the respondent's computer 14a-14d after each question is answered, after all questions on a single page are answered, or at the completion of the survey.

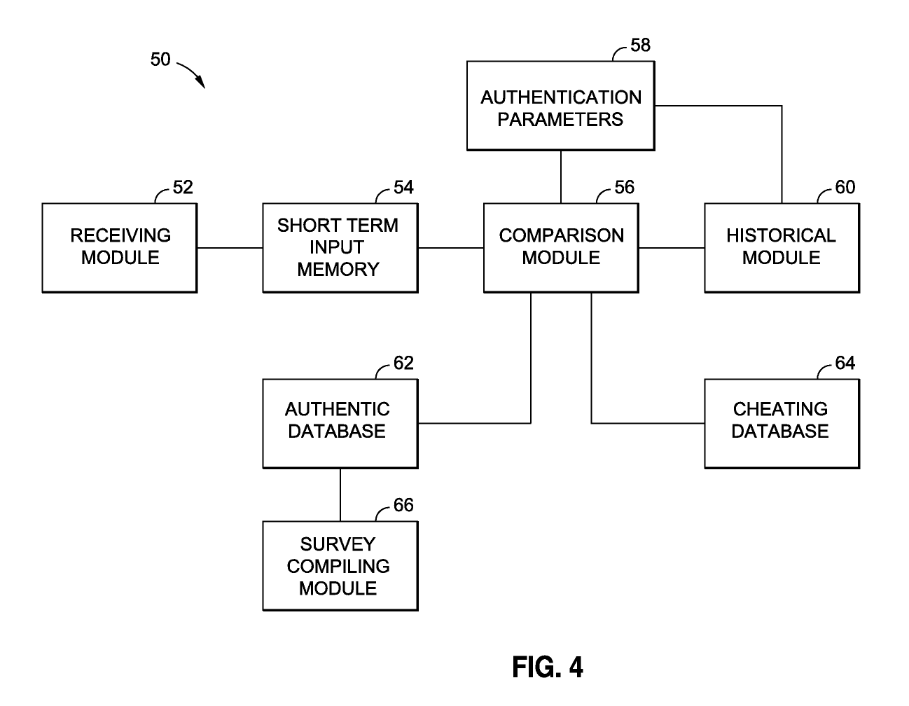

As the survey response is received by the central server 12, it is processed to analyze various pieces of information associated with the survey response to determine the likelihood of cheating. According to one embodiment, the survey input is received and processed on the central server 12 by a verification system 50, as shown in FIG. 4. In one implementation, the verification system 50 includes a receiving module 52, a short term input memory 54, a comparison module 56, an authentication parameters module 58, a historical database 60, an authentic database 62, a cheating database 64 and a survey compiling module 66. The receiving module 52 receives the survey input and communicates the survey input to the short term input memory 54 where the information is temporarily stored during processing.

It is contemplated that one piece of authentication information (i.e., IP address or time zone info) may be used to determine the authenticity of the survey response, or alternatively, a combination of the information may be analyzed to make the final determination. For instance, in the example above wherein the pool of respondents was intended to include those individuals living in the United States, the IP address may be the only piece of information used to verify whether cheating occurred. However, in the other example, wherein the authentication parameter was the time the respondent spent on a particular page of the survey, i.e., 2-4 minutes, other information may be needed to more accurately determine a likelihood of cheating. In other words, the time spent on a particular page alone may not provide a reliable determination as to the true likelihood of cheating, and thus, other categories of data or information may also be analyzed to determine the likelihood of cheating.

The authentication parameters may be stored in the authentication parameters module 58. The authentication parameters module 58 may include an input which allows the operator of the survey to selectively manipulate/change the authentication parameters as desired. The comparison module 56 is in operative communication with the authentication parameters module 58 and is operative to compare the respondent authentication information with the authentication parameters to determine a likelihood of cheating.

In addition to comparing respondent authentication information to authentication parameters for purposes of determining a likelihood of cheating, it is also contemplated that historical respondent information may be used to asses the likelihood of cheating. Along these lines, it may be determined over time that historical answers determined to be the result of cheating may have certain characteristics associated therewith, while true/authentic answers may have other characteristics associated therewith. Therefore, in one embodiment of the verification process, the likelihood of cheating may be determine by comparing the respondent authentication information to a compilation of historical verification authentication information, which may be stored in the historical database 60. In this regard, the “average” verification information may represent a standard or norm. The historical verification authentication information may be compiled over time from several survey responses from various respondents. The historical information may be analyzed to determine a baseline which the verification authentication information may be compared to. In this regard, the baseline may define the authentication parameters.

According to one embodiment, when the respondent sends the survey response, the various data points that define the verification authentication data are combined algorithmically and compared to the historical verification authentication information to produce a “cheat score” for each respondent. This algorithmic combination and comparison may be performed by the comparison module 26. It is contemplated that different weights may be assigned to different sub-scores depending on their reliability as indicators of cheating. In this case, the weighted score is the overall “cheat score.” If a particular response exceeds a certain threshold cheat score set by the researchers, that response can be automatically excluded from the final data set so it is not included in the final analysis.

The following example is provided to illustrate various aspects of the present invention. In this example, the time spent to complete the survey and the number of clicks on each page is analyzed to authenticate a respondent's survey response. With regard to the time, the time per page for each respondent is compared to the average time on that page for all respondents. The amount of time on each page may be combined to determine an overall time for each respondent, which may be compared to a historical average. The times are also used to calculate an average time per question answered, which may also be compared to the overall population.

It is also contemplated that each piece of data collected in the example, i.e., the time per page, the time per question, the overall time, and the number of clicks may be weighted and then combined algorithmically to determine an overall cheat score. For instance, research may show that the time per question is a more reliable indicator of cheating than the number of clicks per page. Thus, the time per question may be multiplied by a weighted factor to assign more emphasis to that variable.

The survey operators may selectively set the thresholds and weights assigned to each variable based on their research and expertise. It is further contemplated that certain embodiments may include means to allow for quick adjustment of the cheating score parameters and weights. For example, over time it may be determined that certain sub scores are more important than they were in the past, or new technologies may be introduced that allow for additional data to be compiled for determining the likelihood of cheating. As these new circumstances become apparent, the cheating detection system may be adjusted to account for the changes. Thus, the systems and methods of the present invention can be continually changed and adapted to improve accuracy over time.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of verifying the accuracy of a response to a web-based survey, the method comprising the steps of:
providing a survey on a website;
receiving a survey response from an electronic device associated with a respondent;
receiving verification data from the electronic device;
analyzing the verification data to determine a likelihood of cheating; and
saving the survey response when the likelihood of cheating is below a threshold.

2. The method recited in claim 1, wherein the survey response is saved in an authentic database when the likelihood of cheating is below the threshold, the method further comprising the step of saving the survey response in a cheating database when the likelihood of cheating meets or exceeds the threshold.

3. The method recited in claim 2, further comprising the step of compiling the data in the authentic database to generate a survey summary.

4. The method recited in claim 1, wherein:
the step of receiving verification data includes receiving electronic identification data associated with the electronic device; and
the step of analyzing the verification data to determine a likelihood of cheating includes comparing the electronic identification data with a historical electronic identification database to identify duplicative responses, and designating a likelihood of cheating above the threshold when at least one duplicative response are identified.

5. The method recited in claim 4, wherein the electronic identification data includes at least one in the group comprised of: an IP address, cookie data, web browser data, and plug-ins installed on a web browser.

6. The method recited in claim 1, wherein:
the step of receiving verification data includes receiving respondent input data associated with the input of the survey response by the respondent; and
the step of analyzing the verification data to determine a likelihood of cheating includes comparing the respondent input data with a low probability respondent input database and designating a likelihood of cheating above the threshold when no match is found between the respondent input data and the low probability respondent input database.

7. The method recited in claim 6, wherein the respondent input data includes at least one in the group comprised of: time zone data associated with the respondent's input, the time spent by the respondent for completing a portion of the survey, the number of mouse clicks on a webpage, and the number of times a key was pressed on a webpage.

8. A method of verifying the accuracy of a web-based survey, the method comprising:
providing a survey on a website;
defining an authentication parameter, the authentication parameter defining at least one characteristic associated with a non-authentic response;
receiving a survey response from a respondent, the survey response including survey input data and respondent authentication information;
comparing the respondent authentication information with the authentication parameters to determine a likelihood of cheating; and
saving the survey input in an authentic database when the likelihood of cheating is below a threshold.

9. The method recited in claim 8, wherein the step of defining an authentication parameter includes:
compiling a respondent authentication database including respondent authentication information from several previous respondents; and
averaging the respondent authentication information in the respondent authentication database.

10. The method recited in claim 8, further comprising the step of compiling the data in the authentic database to generate a survey summary.

11. The method recited in claim 8, further comprising the step of saving the survey response in a cheating database when the likelihood of cheating meets or exceeds the threshold.

12. The method recited in claim 8, wherein:
the respondent authentication information includes information associated with an electronic device associated with the respondent.

13. The method recited in claim 12, wherein the respondent authentication information includes at least one in the group comprised of: an IP address, cookie data, web browser data, and plug-ins installed on a web browser.

14. The method recited in claim 8, wherein:
the step of receiving the survey response includes receiving respondent input data associated with the input of the survey response by the respondent; and
the step of analyzing the verification data to determine a likelihood of cheating includes comparing the electronic identification data with a historical electronic identification database to identify duplicative responses, and designating a likelihood of cheating above the threshold when at least one duplicative response are identified.

15. A method of verifying the accuracy of a response to a web-based survey, the method comprising the steps of:
receiving a survey response from an electronic device associated with a respondent;
receiving verification data from the electronic device;
analyzing the verification data to determine a likelihood of cheating; and
saving the survey response in an authentic database when the likelihood of cheating is below a threshold.

16. The method recited in claim 15, further comprising the step of saving the survey response in a cheating database when the likelihood of cheating meets or exceeds the threshold.

17. The method recited in claim 16, further comprising the step of compiling the data in the authentic database to generate a survey summary.

18. The method recited in claim 15, wherein:
the step of receiving verification data includes receiving electronic identification data associated with the electronic device; and
the step of analyzing the verification data to determine a likelihood of cheating includes comparing the electronic identification data with a historical electronic identification database to identify duplicative responses, and designating a likelihood of cheating above the threshold when at least one duplicative response are identified.

19. The method recited in claim 18, wherein the electronic identification data includes at least one in the group comprised of: an IP address, cookie data, web browser data, and plug-ins installed on a web browser.

20. The method recited in claim 15, wherein:
the step of receiving verification data includes receiving respondent input data associated with the input of the survey response by the respondent; and
the step of analyzing the verification data to determine a likelihood of cheating includes comparing the respondent input data with a low probability respondent input database and designating a likelihood of cheating above the threshold when no match is found between the respondent input data and the low probability respondent input database.
